(19) United States
(12) Patent Application Publication
(10) Pub. No.: US 2022/0306462 A1
(43) Pub. Date: Sep. 29, 2022

(54) METHOD FOR PRODUCING HIGHLY PURE HYDROGEN BY COUPLING PYROLYSIS OF HYDROCARBONS WITH ELECTROCHEMICAL HYDROGEN SEPARATION

(71) Applicant: BASF SE, Ludwigshafen am Rhein (DE)

(72) Inventors: Carsten HENSCHEL, Ludwigshafen am Rhein (DE); Andreas FUESSL, Ludwigshafen am Rhein (DE); Otto MACHHAMMER, Mannheim (DE); Sigmar BRAEUNINGER, Ludwigshafen am Rhein (DE)

(21) Appl. No.: 17/771,131

(22) PCT Filed: Oct. 15, 2020
(86) PCT No.: PCT/EP2020/078978

§ 371 Date: Apr. 22, 2022

(30) Foreign Application Priority Data
Oct. 25, 2019 (EP) 19205347.8

(51) Int. Cl. C01B 3/30; C01B 3/50; B01D 53/32

(52) U.S. Cl. CPC C01B 3/30; C01B 3/503; B01D 53/326; C01B 2203/0272; C01B 2203/0883; C01B 2203/0833; C01B 2203/0861; C01B 2203/0811; C01B 2203/0405; C01B 2203/048; C01B 2203/066

(57) ABSTRACT

The present invention comprises a process for producing hydrogen, wherein in a first stage hydrocarbons are decomposed into solid carbon and into a hydrogen-containing gaseous product mixture, the hydrogen-containing gaseous product mixture, which has a composition in respect of the main components CH4, N2, and H2 of 20% to 95% by volume H2 and 80% to 5% by volume CH4 and/or N2, is discharged from the first stage at a temperature of 50 to 300° C., and this is supplied at a temperature differing from this exit temperature by not more than 100° C. to an electrochemical separation process and, in this second stage, the hydrogen-containing product mixture is separated in the electrochemical separation process at a temperature of 50 to 200° C. into hydrogen having a purity of >99.99% and a remaining residual gas mixture.

The present invention comprises a process for producing hydrogen, wherein in a first stage hydrocarbons are decomposed into solid carbon and into a hydrogen-containing gaseous product mixture, the hydrogen-containing gaseous product mixture, which has a composition in respect of the main components CH4, N2, and H2 of 20% to 95% by volume H2 and 80% to 5% by volume CH4 and/or N2, is discharged from the first stage at a temperature of 50 to 300° C., and this is supplied at a temperature differing from this exit temperature by not more than 100° C. to an electrochemical separation process and, in this second stage, the hydrogen-containing product mixture is separated in the electrochemical separation process at a temperature of 50 to 200° C. into hydrogen having a purity of >99.99% by volume and a remaining amount of residual gas.

Hydrogen:

Hydrogen offers the desired prerequisites to become the key factor for the energy supply of the future. The transport sector in particular is faced with the major challenge of becoming more climate-friendly. In Germany, transport is responsible for almost 20 percent of total CO2 emissions, with a good half of this coming from private transport.

The introduction of electromobility, which includes battery-electric and fuel-cell-electric vehicles, allows the transport sector to reduce its dependence on petroleum-based fuels. In the transport sector, hydrogen is a new fuel that produces no local pollutants when used with fuel-cell technology.

Depending on the feedstock and on the process from which the hydrogen is produced, it has different levels of purity. In order to be able to use hydrogen in fuel-cell applications, it is produced in a very high quality (99.97%, specified in ISO FDIS 14687-2), since impurities have effects on catalysts and membranes.

Hydrogen is currently produced in a mainly decentralized manner in relatively large steam methane reforming (SMR) production units, with the hydrogen separated from the resulting gas mixtures by pressure-swing adsorption. The technology of pressure-swing adsorption is limited to hydrogen-rich gases (content preferably >50% by volume, depending on which other gases are present); furthermore, only 70 to 85% of the hydrogen is separated, the remaining hydrogen being needed for desorption of the secondary components. The separated hydrogen is liquefied or compressed and brought by appropriate transport vehicles with high-pressure containers (500 bar) to the place where it is needed, for example a hydrogen filling station.

As an alternative, consideration is being given to hydrogen pipeline networks in which the hydrogen is transported at different pressure levels. However, such pipeline networks have very high infrastructure costs and also require complex approval procedures, which is why realization in the near future seems somewhat unlikely.

Consideration is also being given to the production of hydrogen in a decentralized manner in smaller production units, for example by electrolysis or steam reforming, thereby shortening the transport route or eliminating it altogether.

Electrolysis, like the electrochemical hydrogen-separation membrane process (EHS), is a membrane process and is more suitable for small plants than for large ones because of the low economy of scale (cost benefits arising from the size of the plant). The reason for the limited economy of scale is the direct dependence of the capacity on the electrochemically active area, which in turn translates into a corresponding number of membrane electrode assemblies and stacks. The electrolytic cleavage of water into hydrogen and oxygen requires at least 6 times as much energy as the thermal cracking of hydrocarbons into hydrogen and carbon. In the case of electrolysis, this energy must be provided in the form of electric current. Even when the generated electricity has a small carbon footprint, electrolysis hydrogen is associated with a higher carbon footprint than pyrolysis hydrogen because of the high power consumption [O. Machhammer, A. Bode, W. Hormuth, “Financial and Ecological Evaluation of Hydrogen Production Processes on Large Scale”, Chem. Ing. Tech. 2015, 87, No. 4, 409].

Another option for producing hydrogen in a decentralized manner in a small-scale plant is miniaturization of the steam-methane reforming (SMR) process developed for large-scale plants. Such a small plant does not differ from a world-scale plant in the number of machines and items of apparatus. Only the machines and items of apparatus are smaller. However, the specific consumption of feedstocks and energy and of heat-transfer capacity is approximately the same. The heat-transfer capacity is relevant to the economic evaluation of a process in that capital costs for chemical plants correlate directly with this heat-transfer capacity (see Lange J.-P., Fuels and chemicals: manufacturing guidelines for understanding and minimizing the production costs, CATECH, volume 5, No. 2, 2001).

If process concepts of large-scale plants are applied, this usually leads to high specific capital costs for decentralized small-scale plants. The capital costs for a plant overall are a multiple of the sum of all costs for the individual items of apparatus. The multiplier that quantifies this multiple is termed the plant factor. For world-scale plants, the plant factor is of the order of three. If the production capacity is reduced by keeping the plant concept the same and using smaller machines and items of apparatus, the plant factor can rise to 10.

Pyrolysis Prior Art:

Pyrolysis is a thermal process that can be used to produce hydrogen and high-purity carbon from hydrocarbons (for example from natural gas) with a low carbon footprint. Pyrolysis is a thermal equilibrium process that requires energy. The number of moles in the gas phase increases with conversion, therefore the higher the temperature and the lower the H2 partial pressure, the higher the conversion. The pyrolysis of hydrocarbons therefore takes place at high temperatures in the range of 800 and 1600° C. or—in the case of high-temperature plasma processes—even higher. The carbon (pyrolytic carbon) is generated in a highly pure form and can be used in high-price segments, for example as electrode material or as a precursor for the production of graphite for Li-ion batteries.

For the realization of these high temperatures in pyrolysis processes and in coke production, there are various solutions in the prior art.

In DE 600 16 59 T, U.S. Pat. No. 3,264,210, and CA 2 345 950, oxidative processes are used as the heat source in various ways.

U.S. Pat. No. 2,389,636, US 2 600 07, U.S. Pat. No. 5,486,216, and in U.S. Pat. No. 6,670,058 describe the use of the solid bed as a heat transfer medium.

WO2013/004398A2 proposes a gas-phase heat-transfer medium. This is preferably a H2- or N2-rich gas that is heated in an external combustion chamber and introduced into a pyrolysis zone.

In U.S. Pat. Nos. 2,799,640, 3,259,565, and DE 1 266 273, an electric heat source is used. U.S. Pat. No. 2,982,622 describes a resistance-heated fluidized bed process. In this process, the electrical conductivity of carbon is used to resistively heat a fluidized bed of carbon particles. The process is realized in a moving-bed reactor in which the solid particles are passed through the reactor from top to bottom following gravity and the natural gas to be cracked is passed through the reactor from bottom to top.

WO2018/083002 A1 describes a cyclic operating mode with a combination of a reactor and a regenerator. Carrier particles are cycled through the reactor. The regenerator is filled with inert material. Reactor and regenerator are connected to each other via a combustion chamber in which some of the pyrolytically generated hydrogen is burnt with air or 02 to cover the required energy requirement. Through this flow, all products exit the apparatus in a cooled state.

DE 2 420 579 describes a process based on an inductively-heated carbon bed.

DE 692 08 686 T, WO 2018/165483, and WO 2016/126599 describe the use of a plasma burner.

Other development approaches include the thermocatalytic decomposition of methane [Smolinka, T.; Günther, M. (Fraunhofer ISE); Garche, J. (FCBAT): NOW-Studie “Stand and Entwicklungspotenzial der Wasserelektrolyse zur Herstellung von Wasserstoff aus regenerativen Energien” [Current situation and development potential of water electrolysis for the production of hydrogen from renewable energies], revised version of 05.07.2011] and the purely thermal decomposition of methane in liquid metals [A. M. Bazzanella, F. Ausfelder, “Low carbon energy and feedstock for the European chemical industry”, DECHEMA-Technology study, June 2017].

The prior art in low-temperature plasma technology is given in [A. I. Pushkarev, et. al. “Methane Conversion in Low-Temperature Plasma, High Energy Chemistry”, vol. 43 No. 3, 2009].

For the purification of pyrolytically produced hydrogen, pressure-swing adsorption (PSA) units and membrane processes, for example ceramic membranes and Pd-based membranes, have inter alia been described, as has a combination of the two variants (see U.S. Pat. Nos. 6,653,005 and 7,157,167). The use of electrochemical separation for providing high-purity hydrogen is not described in these documents.

EHS Prior Art:

The separation of hydrogen from reaction mixtures, especially in reactions with thermodynamically limited conversions, is an important challenge for higher yields in required products. Electrochemical hydrogen separation (EHS) is an electrochemical process based on the transport of protons (H+ ions) through ion-conducting membranes and is a novel use for fuel-cell technology (see WO 2016/50500 and WO 2010/115786). The water-containing mixture enters the anode chamber, where it is oxidized to protons and electrons. An electric power supply provides the driving force for transport of the protons through the catalyzed membranes, where they couple at the cathode to form “new” hydrogen (also referred to as “evolving” hydrogen at the electrode). Since the membranes transport only protons, the other constituents of the gas mixture remain in the offgas system. EHS is thus capable of producing hydrogen of high purity (>99.99% H2). This high purity, such as is needed for fuel cells, for example, is achievable only very laboriously by other H2 separation processes, for example cryogenic gas separation (cold box), pressure-swing adsorption (PSA), temperature-swing adsorption (TSA), and conventional membrane separation technologies using hydrogen-selective metal membranes (for example palladium, palladium alloys),

In contrast to EHS, in which the hydrogen is removed from the gas stream, in PSA, TSA, and cold box all gas components are removed, with only hydrogen remaining in the product gas stream. The higher the gas pressure and the lower the gas temperature, the easier the separation of the adsorbable components. Conventional membrane separation technologies are based on the driving force of the partial pressure, which means it is possible to achieve only low throughput. By contrast, electrochemical hydrogen separation is not limited by the hydrogen partial pressure difference, since an electrical potential difference is used as the driving force.

Processes for separating hydrogen and nitrogen that are based solely on the difference in boiling temperatures, for example cold box, are costly and do not afford pure hydrogen. According to [Z. Riebel, Hydrogen management in refineries, Petroleum $ Coal, ISSN1337-7027, 54 (4), pp. 357-368, 2012], purities of no higher than 98% are achieved with cryogenic separation processes. With separation by PSA or TSA, it is however possible to achieve purities of 99.0 to 99.999%. The separation is however accompanied by loss of at least 10% of the hydrogen.

Adsorption processes such as PSA or TSA are based inter alia on the effect that the more easily substances condense, the more readily they undergo adsorption. Hydrogen has a lower tendency to condense than any other gas, which means that all gas components undergo adsorption, i.e. are removed from the gas stream, before it does. This association between condensation temperature/boiling temperature and tendency to adsorption explains why it is easier to separate CO2 or CH4 from H2 than O2 or N2. The order of boiling temperatures at ambient pressure is: CO2 (−78° C.), CH4 (−162° C.), O2 (−183° C.), N2 (−196° C.), H2 (−252° C.).

Hydrogen separation technologies that are volume processes, for example PSA or TSA, are more economical for large plant capacities. For small plant capacities, these volume processes are however economically less favorable than EHS.

If the plant capacity is high (e.g. >1000 kg H2/h), the concentration of secondary components other than hydrogen in the pyrolysis product stream is low (e.g. <approx. 25 mol %), and the secondary components of the product stream are easily adsorbed (for example CH4), then hydrogen can be economically obtained from this product stream in a purity of up to 99.9% with the aid of the two separation technologies PSA or TSA.

If the plant capacity is on the other hand low (e.g. <100 kg H2/h) and hydrogen is wanted in the highest possible purity (for example H2 filling station for fuel-cell vehicles), then EHS is the more economical separation process. The EHS process is a surface process, since the membrane surface area of an individual cell is limited to 25 to 3000 cm². An increase in capacity can be achieved only by increasing the number of cells. This means that a large-capacity plant specifically is not significantly cheaper than a small-capacity plant. In other words: EHS has only low economy of scale. For the economic efficiency of the EHS, it is moreover of no consequence how readily the secondary components can be condensed.

Problem:

The challenge for the future lies inter alia in the development of small, flexible, and cost-efficient plants that can produce high-purity hydrogen, especially with a low CO2 footprint, directly on site, for example installed at the hydrogen filling station, at short notice, and optionally in an instationary manner.

A process concept is therefore sought that, despite a small production capacity, has a small plant factor and thus low specific investment costs. In addition, the process concept should accommodate as many process steps as possible in few items of apparatus and have the lowest-possible specific heat-transfer capacity.

Solution:

A process for producing hydrogen, wherein in a first stage hydrocarbons are decomposed into solid carbon and into a hydrogen-containing gaseous product mixture, the hydrogen-containing gaseous product mixture, which has a composition in respect of the main components CH4, N2, and H2 of 20% to 95% by volume H2 and 80% to 5% by volume CH4 and/or N2, is discharged from the first stage at a temperature of 50 to 300° C., and this is supplied at a temperature differing from this exit temperature by not more than 100° C. to an electrochemical separation process and, in this second stage, the hydrogen-containing product mixture is separated in the electrochemical hydrogen-separation membrane process at a temperature of 50 to 200° C. into hydrogen having a purity of >99.99% and a remaining amount of residual gas.

In the second stage, the hydrogen-containing product mixture is advantageously supplied to the anode side of a membrane electrode assembly, after which at least part of the hydrogen present in the product gas is separated electrochemically by means of the membrane electrode assembly, wherein on the anode side of the membrane at least part of the hydrogen is oxidized to protons on an anode catalyst and the protons after passing through the membrane are on the cathode side reduced to hydrogen on the cathode catalyst.

In terms of the carbon footprint of a hydrogen filling station, the combination of a “low-cost” methane pyrolysis with an EHS is more expedient than the use of decentralized electrolysis, mini-SMR, or centralized H2 production in world-scale plants combined with transport to the filling station. A “low-cost” pyrolysis is understood to mean a pyrolysis that, by virtue of the combination with an EHS, is subject to fewer process constraints than a standalone pyrolysis.

In this context, “few process constraints” means the following:
The methane conversion can be lower, preferably 30% to 99.9%, more preferably 65% to 99.0%, especially 85% to 98%. This means that the pyrolysis can be operated at lower temperatures, preferably 650 to 1200° C., more preferably at 750 to 1100° C., preferably 800 to 1100° C., preferably 900 to 1050° C., especially at 950 to 1050° C., higher pressures, preferably at 1 to 30 bar, more preferably at 1 to 10 bar, especially at 1 to 5 bar, and/or with shorter residence times of advantageously 1 s to 5 min, preferably 1-30 s, especially 1-5 s. Preferably, the reaction temperature is 1100 to 1200° C. and the residence time is 1 to 5 s, or the reaction temperature is 1000 to 1100° C. and the residence time is 5 s to 30 s, or the reaction temperature is 900 to 1000° C. and the residence time is 30 s to 1 min, or the reaction temperature is 750 to 900° C. and the residence time is 1 to 5 min.
Lower temperatures reduce the expenditure on apparatus, for example choice of materials, heat integration.
Higher pressures in the pyrolysis reduce the expenditure on compression when H2 subsequently has to be compressed to a few hundred bar. For example, compression from 1 to 10 bar requires just as much energy as from 10 to 100 bar.
In addition, the fact that the methane content in the pyrolysis product gas does not impact greatly on economic efficiency makes the conveyance of the circulation for the pyrolytic carbon that is necessary for heat integration easier. For example, methane (natural gas) can be used as medium for the pneumatic conveyance of the circulation. In addition, leakages between process areas in the pyrolysis apparatus play only a minor role.

The particular characteristic of the electrochemical hydrogen-separation membrane process (EHS) is the low-cost separation from diluted gases of hydrogen (H₂) in very high purity. This means that the upstream pyrolysis process for generating the hydrogen can be designed very simply and cost-efficiently.

Description of the Pyrolysis:

In the first process stage, the (thermal) decomposition of hydrocarbons to solid carbon and a hydrogen-containing gaseous product mixture, it is possible to use all pyrolysis processes known to those skilled in the art of (thermal) decomposition technology. Preferably, the energy required for decomposition is provided autothermally, via low-temperature plasma and/or with the aid of electrical resistance heating.

Alongside the price of natural gas, the variable costs of thermal decomposition depend on the form of energy input. The substoichiometric combustion of hydrocarbons with air is in this context more favorable than substoichiometric combustion with pure oxygen or the use of electric current, because in addition to combustion, the hydrocarbons are in part reformed to CO and not pyrolyzed to carbon. Furthermore, atmospheric nitrogen (N₂) in the gas stream lowers the hydrogen partial pressure, thereby increasing the equilibrium conversion.

The use of electric current as an energy carrier results in higher variable costs, but in return enables lower expenditure on apparatus, with consequently lower fixed costs. In addition, electrification in the process itself generates practically no CO2. Moreover, the use of electric power allows low-temperature plasma reactors to be employed. Since it is the electrons and not the molecules that are excited in the low-temperature plasma, rapid methane conversion can be achieved even at low temperatures of 50° C. to 500° C., which results in low capital costs.

Process Parameters that Apply for all Concepts:

In principle, all hydrocarbons can be introduced into and decomposed in the reaction space, but preference is given to light hydrocarbons, for example methane, ethane, propane, and butane. The preferred option is natural gas, especially natural gas having a methane content from 75 to 99.9% of the molar fraction.

The hydrogen-containing gaseous product mixture formed in the decomposition of hydrocarbons preferably has the following composition in respect of the two main components CH4, N2, and H2, in % by volume: Advantageously this is 10% to 99% by volume H2 and 90% to 1% by volume CH4 and/or N2, preferably 20% to 95% by volume H2 and 80% to 5% by volume CH4 and/or N2, preferably 40% to 90% by volume H2 and 60% to 10% by volume CH4 and/or N2, preferably 65% to 90% by volume H2 and 35% to 10% by volume CH4 and/or N2, preferably 80% to 90% by volume H2 and 20% to 10% by volume CH4 and/or N2.

Deposition of Pyrolytic Carbon

There are in principle two different mechanisms for carbon deposition:

1) If a carrier surface, e.g. carbon surface, is already present and if the gas volume in relation to the surface area is very low, the pyrolytic carbon will be deposited as a compact layer predominantly on the provided carrier surface. If the carrier surface is hotter than the gas volume, this mechanism will be boosted further.

2) If the gas volume is on the other hand large in relation to the surface area (for example the reactor inner wall), it will be predominantly soot that forms, i.e. large numbers of tiny pyrolytic carbon particles that in the worst case can block the entire reactor volume. The formation of soot is boosted by high gas temperatures and pressures. If soot forms, it should for reasons of good heat integration be separated from the gas stream, if at all possible at room temperature, for example by means of: cyclone, filter, and/or particle beds.

Particle beds act in this context like a depth filter. The pyrolytic carbon coats the surfaces of the particles present in the beds and over time closes all the spaces between particles. If the loss of pressure above the particle bed becomes too great, the particle bed must be replaced by fresh, uncoated particles.

Low-Temperature Plasma

A thermal decomposition of hydrocarbons operated by means of low-temperature plasma is known to those skilled in the art of low-temperature plasma technology and described for example in “Methane Conversion in Low-Temperature Plasma” by Pushkarev et al in High Energy Chemistry, 2009, vol. 43, No. 3, pages 156-162.

The low-temperature plasma pyrolysis process advantageously comprises the following process steps:
1) Providing a particle bed composed of a carrier material.
2) Contacting the particle bed of carrier material with the carbon-containing hot pyrolysis gas, such that the particle bed of carrier material is heated and carbon is deposited in the particle bed.
3) Passing cold feed gas consisting of reactant gas and recirculated gas over this heated particle bed, such that this feed gas is heated and the carbon-laden particle bed is cooled
4) Further heating of the feed gas by a plasma burner to produce the hot pyrolysis gas.
5) Replacing the cooled, laden particle bed with a cold particle bed.

Thermal Pyrolysis:

In contrast to low-temperature plasma, thermal pyrolysis requires high reaction temperatures (>1000° C.). The energy required for heating the gas stream used is of the order of the enthalpy of reaction for the pyrolysis. Therefore, the maximum possible heat integration is advantageous, such that for example the cooling of the hot product streams is utilized for heating the feed streams.

Since methane already begins to pyrolyze above 450° C., recuperative heat exchange is ruled out, because pyrolytic carbon would be deposited on the heat exchanger surfaces above 450° C. and would block the heat exchanger over time.

Regenerative heat exchange is on the other hand advantageous because it opens up the possibility of discharging the pyrolytic carbon from the process at the same time as the heat exchange.

The temperatures in the pyrolysis process are in the case of thermal pyrolysis advantageously between 1000 and 1600° C., especially between 1100 and 1300° C.

Preferably, the pressure in the pyrolysis process is in the case of thermal pyrolysis in the first stage advantageously 1 to 10 bar, especially 1 to 5 bar.

Advantageously, the thermal reaction is carried out in the presence of solid carrier materials, preferably heat-transfer materials, on which the carbon formed in the hydrocarbon cracking reaction is primarily deposited, more particularly to an extent of more than 90% based on the maximum pyrolyzable carbon content. These solid carriers can be used for regenerative heat integration.

The thermal decomposition can advantageously be carried out in a fixed-bed reactor, fluidized-bed reactor or moving-bed reactor, wherein the term “fluidized bed” is also understood as meaning a production bed if the solid reactor content in the reaction zone is at least partially fluidized and if above and/or below the reaction zone the solid reactor content is moving but is no longer fluidized.

Preferably, the carrier is passed through the reaction space in the form of a moving bed, wherein the hydrocarbons to be decomposed are passed through in countercurrent to the carrier. The reaction space is advantageously designed as a vertical shaft, optionally as a conical shaft, such that the movement of the moving bed arises under the action of gravity alone. The moving bed is advantageously homogeneous and capable of even through-flow.

The carrier materials of this reaction bed are advantageously thermally stable within a range from 1000 to 1800° C., preferably 1300 to 1800° C., more preferably 1500 to 1800° C., especially 1600 to 1800° C.

Useful temperature-resistant carrier materials are, for example, advantageously ceramic carrier particles, especially materials in accordance with DIN EN 60 672-3, for example alkali metal aluminosilicates, magnesium silicates, titanates, alkaline earth metal aluminosilicates, aluminum and magnesium silicates, mullite, alumina, magnesium oxide and/or zirconium oxide. It is also possible to employ as temperature-resistant carrier materials non-standardized ceramic high-performance materials such as quartz glass, silicon carbide, boron carbide and/or nitrides. These heat-transfer materials may have a different expansion capacity compared to the carbon deposited thereon.

Additionally advantageous is the use of carbon-containing material in pellet form. A carbon-containing pellet material is in the present invention understood as meaning a material that advantageously consists of solid granules. The carbon-containing pellet material is advantageously spherical. The pellet material advantageously has a granule size, i.e. an equivalent diameter determinable by sieving with a particular mesh size, of 0.05 to 100 mm, preferably 0.1 to 50 mm, further preferably 0.2 to 10 mm, especially 0.5 to 5 mm. In the process according to the invention, it is possible to use a large number of different carbon-containing pellet materials. A pellet material of this kind may for example consist predominantly of carbon, coke, coke breeze and/or mixtures thereof. In addition, the carbon-containing pellet material may comprise 0% to 15% by weight based on the total mass of the pellet material, preferably 0% to 5% by weight, of metal, metal oxide and/or ceramic.

ATP

An autothermally operated thermal decomposition (pyrolysis), or ATP, of hydrocarbons is known to those skilled in the art of thermal decomposition technology and is described for example in Manfred Voll, Peter Kleinschmit, “Carbon, 6. Carbon Black”, Ullmann's Encyclopedia of Industrial Chemistry, Wiley, 2012.

The ATP is advantageously carried out at temperatures of between 500° C. and 1500° C., preferably between 600° C. and 1300° C., more preferably between 700° C. and 1200° C. The pressures are advantageously between 1 and 10 bar, preferably between 1 and 5 bar, and more preferably between 1 and 3 bar.

In combination with an EHS, the temperature can advantageously be lower and the conversion accordingly lower and air can advantageously be used instead of costly pure oxygen, because neither a high methane content nor a high N2 content in the pyrolysis product gas reduces the economic efficiency of EHS compared to PSA. For example, the temperature is 650 to 1200°, preferably 750 to 1100° C., especially 800 to 1000° C. For example, the pressure is 1 to 30 bar, more particularly 1 to 10 bar, especially 1 to 5 bar.

Useful carrier materials are, for example, advantageously ceramic carrier particles, especially materials in accordance with DIN EN 60 672-3, for example alkali metal aluminosilicates, magnesium silicates, titanates, alkaline earth metal aluminosilicates, aluminum and magnesium silicates, mullite, alumina, magnesium oxide and/or zirconium oxide. It is also possible to employ as temperature-resistant carrier materials non-standardized ceramic high-performance materials such as quartz glass, silicon carbide, boron carbide and/or nitrides. These heat-transfer materials may have a different expansion capacity compared to the carbon deposited thereon.

Particular preference is given to the use of carbon-containing material in pellet form. A carbon-containing pellet material is in the present invention understood as meaning a material that advantageously consists of solid granules. The carbon-containing pellet material is advantageously spherical. The pellet material advantageously has a granule size, i.e. an equivalent diameter determinable by sieving with a particular mesh size, of 0.05 to 100 mm, preferably 0.1 to 50 mm, further preferably 0.2 to 10 mm, especially 0.5 to 5 mm. In the process according to the invention, it is possible to use a large number of different carbon-containing pellet materials. A pellet material of this kind may for example consist predominantly of carbon, coke, coke breeze and/or mixtures thereof. In addition, the carbon-containing pellet material may comprise 0% to 15% by weight based on the total mass of the pellet material, preferably 0% to 5% by weight, of metal, metal oxide and/or ceramic.

The ATP advantageously comprises the following process steps:
1) Providing a particle bed containing unladen carrier material.
2) Burning a reactant gas or product gas with air to produce a hot pyrolysis gas for providing the enthalpy of reaction.
3) Mixing this hot pyrolysis gas with the reactant gas (advantageously natural gas), such that the reactant gas pyrolyzes to H2 and carbon.
4) Contacting the particle bed of unladen carrier material with the carbon-containing hot pyrolysis gas, such that the particle bed of unladen carrier material is heated and carbon is deposited in the particle bed.
5) When the particle bed has been heated and no more carbon can be taken up: passing of the cold reactant gas over this particle bed. This heats the reactant gas and cools the carbon-laden particle bed.
6) Replacing the cooled laden particle bed with a cold particle bed.

The ATP offers the best prerequisites for low-cost pyrolysis in combination with EHS: The energy input is advantageously achieved by burning the reactant gas or product gas with air. This means that neither costly electric current nor costly pure oxygen is required for the energy input. The disadvantage that is usually present when using combustion air—that the hydrogen-containing product gas mixture comprises large amounts of nitrogen—does not play a negative role when using EHS as a hydrogen separation process.

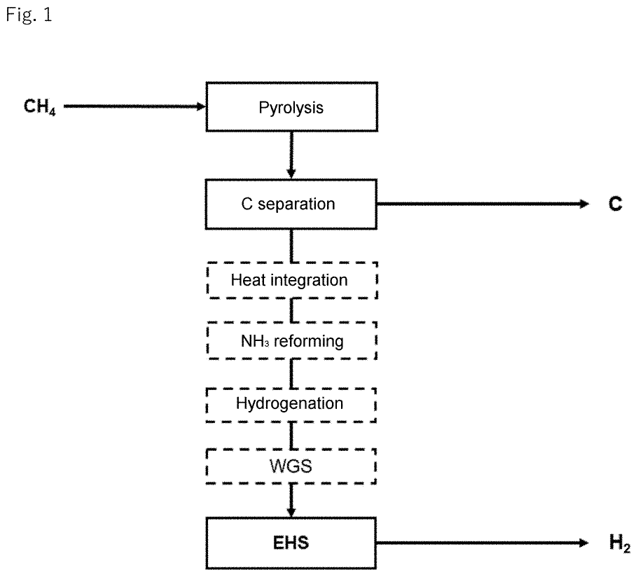

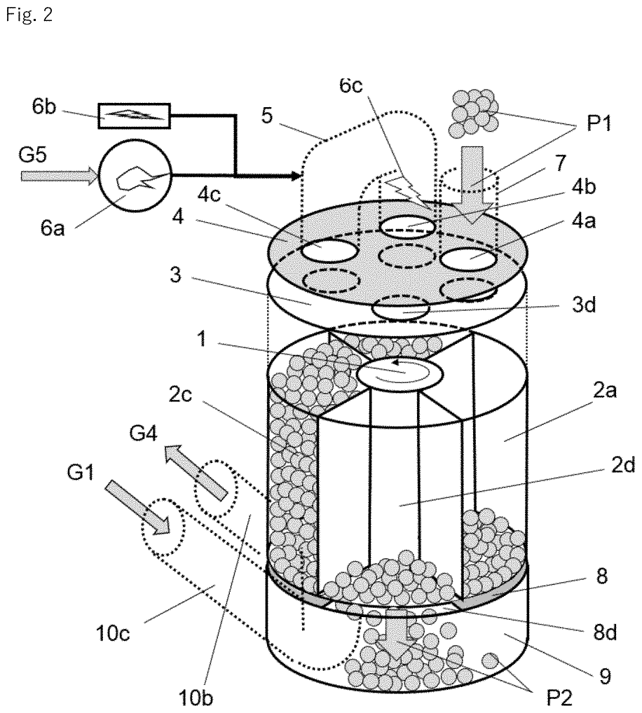

According to the invention, a reactor concept is proposed that is based on a revolver principle (FIG. 2). A vertical drum (1) rotating in cycles a section at a time is divided, for example, into 4 segments (2a-d) by partition walls arranged in a star shape and providing good thermal insulation. The segments are advantageously open at the bottom and closed at the top by a plate (3) comprising one hole per segment (3a-d). Above plate 3 there is advantageously a fixed plate 4 having only 3 holes (4a-c) in the same shape and position as (3a-c). Segment (2d) is advantageously closed at the top because one hole (4d) is missing in this cycle.

The holes (4c) and (4b) are advantageously connected via a tube (5, shown with a dotted line), in which the device for the energy input (6c, shown as a lightning flash) may advantageously be located.

The energy input may alternatively also be achieved by generating a hot gas outside the tube, for example in a burner (6a) or in a plasma generator (6b), which is then advantageously introduced into the tube 5.

A tube (7, also shown with a dotted line) advantageously opens into hole (4a) which is situated above hole (3a). Particles (P1), also termed carrier material, are advantageously supplied through tube (7) to segment (2a); these act as depth filters for separating the pyrolytic carbon and/or as regenerators for heat integration.

The segments (2a-c), which are advantageously open at the bottom and advantageously rotate a section at a time, are advantageously closed at the bottom by a fixed plate (8) to such an extent that advantageously no particles are able to enter the space (9) below. The plate (8) advantageously has only a corresponding opening (8d) for segment (2d). Particles (P2) can advantageously exit segment (2d) into the space (9) below.

Plate (8) advantageously has tube feeds (10b and 10c, shown with a dotted line) beneath both segments (2b) and (2a). These tube feeds are advantageously designed in such a way that gases can flow into the segments, but no particles from the segments are able to enter the tubes. This can be achieved for example by a close-mesh screen. From tube (10b), cold pyrolysis product gas (G4) is advantageously withdrawn from segment (2b), with cold feed gas (G1) advantageously flowing into segment (2c) through tube (10c).

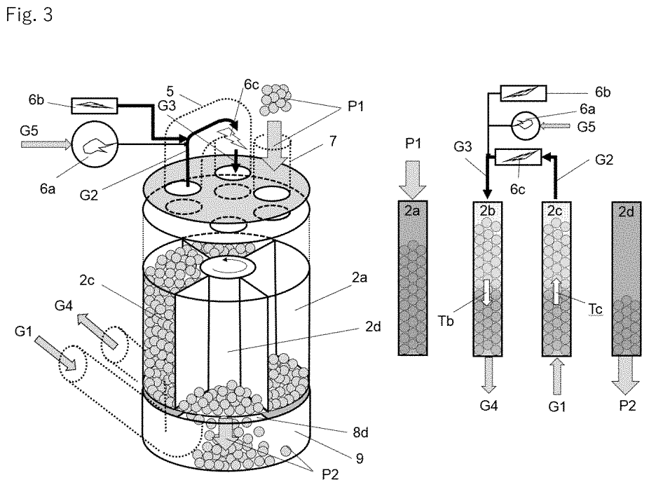

In FIG. 3, the individual segments (2a-d) are drawn in a linear sequence to illustrate what is happening in the individual segments at any given moment x. A dark background means that the segment or the particles therein are cold. A light background means that the segment or the particles therein are hot. The transitions from dark to light or light to dark represent moving temperature fronts. The arrows (Tb) and (Tc) indicate the direction of movement of the temperature fronts.

There follows a description of one cycle:
Segment (2a) is located beneath the tube (7) and is filled with fresh particles (P1).
Passing from the tube (5) into segment (2b) is the hot reaction gas (G3), which heats the fresh and still-cold particles to reaction temperature.
Cold feed gas (G1) flows into segment (2c) and cools the hot particle bed as it rises. In return, the supplied natural gas is heated by the hot particles and enters tube (5) as hot feed gas (G2).
If the energy input is achieved by burning a mixture of fuel gas and air (G5) in a burner (6a) or by an electrically generated high-temperature plasma (6b), then these two devices (6a) or (6b) generate a very hot gas that is mixed with the preheated feed gas (G2) in the tube (5) to form the hot reaction gas (G3).
The hot reaction gas (G3) may already contain pyrolytic soot formed on entry into segment (2c). In accordance with the invention, the major part of the pyrolysis reaction takes place in segment (2b).
   Segment (2d) is located above the opening (8d) such that the cooled particles (P2) laden with pyrolytic carbon are able to fall into the chamber (9) beneath in order to be discharged therefrom.

The drum stays in the same position for as long as the particle bed in segment (2c) needs to cool down. This completes one cycle and the drum then rotates one segment further. The segment that had been in the previous cycle (2a) becomes segment (2b) in the new cycle, and so on. It is assumed that the time taken to fill segment (2a) and to empty segment (2d) is shorter than the time taken to cool the particle bed in segment (2c).

As can be seen, four process operations are according to the invention combined in a single item of apparatus, which would otherwise take place in up to four apparatus items, said operations comprising reaction, heat input to cover the heat of reaction, separation of the pyrolytic carbon, and heat recovery (heating of the natural gas and cooling of the pyrolytic carbon).

Alternatively, the drum can be divided into segments, the number of segments being N_{segment}=2+2*n, where n=1, 2, 3, etc.

The options for the processing and recirculation of the particle bed from segment (d) are known to those skilled in the art of solids handling technology.

Resistance Heating:

A thermal decomposition of hydrocarbons operated by means of resistance heating is known to those skilled in the art of thermal decomposition technology and is described for example in CH 409890, U.S. Pat. No. 2,982,622, and International Patent Application No. PCT/EP2019/051466.

In a preferred execution, two electrodes are installed in the particle beds, between which the particle beds function as electrical resistors and are heated as the current passes through as a result of electrical conduction losses. The current flow may either be transverse to the flow directions of the particle beds or longitudinal thereto.

Since all conversion processes require energy, it may be advantageous to design the pyrolysis stage of the process of the invention as a hybrid process, such that it can also be operated with surplus electricity obtained from renewable sources (see WO 2014/090914, European patent application No. 19178437.0).

EHS:

The technology of electrochemical hydrogen separation is based on ion-transport membranes that selectively conduct protons (H+). These membranes are known from other uses, for example electrodialysis, fuel cells, and water electrolysis. The setup for hydrogen separation is largely identical to a fuel cell setup. The core of the EHS system is the membrane electrode assembly (MEA). On the anode side, hydrogen molecules are oxidized on a catalyst to protons, which pass through the proton-selective membrane to the cathode side, while electrons travel through an external electrical circuit to the cathode. As long as current is being applied, the EHS system thus separates the hydrogen from gas mixtures.

The technology of electrochemical hydrogen separation is described for example in WO 2016/50500 and WO 2010/115786.

The catalytically active material used may be the customary compounds and elements known to those skilled in the art that can catalyze the dissociation of molecular hydrogen into atomic hydrogen, the oxidation of hydrogen to protons, and the reduction of protons to hydrogen. Suitable examples are Pd, Pt, Cu, Ni, Ru, Fe, Co, Cr, Mn, V, W, tungsten carbide, Mo, molybdenum carbide, Zr, Rh, Ru, Ag, Ir, Au, Re, Y, Nb, and alloys and mixtures thereof, with preference in accordance with the invention given to Pt. The catalytically active materials may also be present in supported form, preferably with carbon as support. In a further development of the membrane electrode assembly, the amount of the catalytically active material in the cathode catalyst is 0.1 mg/cm2 to 2.00 mg/cm2, preferably 0.1 mg/cm2 to 1 mg/cm2, based on the total surface area of the anode and cathode.

The membrane used in accordance with the invention selectively conducts protons, that is to say, in particular, that it is not electron-conducting. In accordance with the invention, it is possible to use for the membranes all materials known to those skilled in the art from which proton-conducting membranes can be formed. It is also possible to use in accordance with the invention selectively proton-conducting membranes such as are known from fuel-cell technology.

Materials that are particularly suitable for the production of gas-tight and selectively proton-conducting membranes are polymer membranes. Suitable polymers are sulfonated polyether ether ketones (S-PEEK), sulfonated polybenzimidazoles (S-PBI), and sulfonated fluorinated hydrocarbon polymers (for example Nafion®). It is also possible to use perfluorinated polysulfonic acids, styrene-based polymers, poly(arylene ethers), polyimides, and polyphosphazenes.

Very particular preference is given to using membranes made of polybenzimidazoles, especially MEAs based on polybenzimidazole and phosphoric acid, such as those marketed under the Celtec-P® name by BASF SE, for example.

The operating conditions of the EHS system are strongly dependent on the MEA chosen. When using the Celtec® technology, the use of a voltage of 0.1 to 0.4 V and a current of 0.2 to 1 A/cm² is advantageous. The separation of H2 is based not on differential pressure, but on electrochemistry. EHS can therefore be operated advantageously at ambient pressure. Provided there is no differential pressure between the anode and the cathode, a higher pressure which results in a higher separation rate, is advantageous.

The hydrogen content in the hydrogen-containing product gas from stage 1, the pyrolysis stage, is advantageously within a range from 1% by volume to 99% by volume, preferably 5% to 95% by volume, preferably 10% to 95% by volume, preferably 20% to 95% by volume, preferably 40% to 90% by volume, especially 65% to 90% by volume, of hydrogen. The hydrogen separation rate is typically between 60% and 99%, preferably 70 to 95%, especially 80% to 90%, wherein the higher the separation rate, the higher the electrical energy requirement of an EHS.

The water content in the hydrogen-containing feed gas is advantageously within a range from 0.5 to 50%, preferably 0.5 to 5%, especially 0.5 to 1%.

The current density is advantageously 0.1 to 1 A/cm², preferably 0.2 to 0.7 A/cm², especially 0.2 to 0.5 A/cm². The voltage is advantageously 1 to 1000 mV, preferably 100 to 800 mV, especially 150 to 350 mV.

These electrochemical hydrogen separation systems are operated at temperatures of advantageously from 50 to 200° C., preferably from 120 to 200° C., preferably from 150 to 180° C., especially 160 to 175° C. The pressure is advantageously 0.5 to 40 bar, preferably 1 to 10 bar, especially 1 to 5 bar. The pressure difference between the anode side and the cathode side is advantageously less than 1 bar, preferably less than 0.5 bar.

This mode of operation allows a high tolerance to gas impurities, for example CO (3%) and H2S (15 ppm), to be achieved.

This relatively low temperature permits relatively rapid and material-sparing start-up and shut-down, which is an advantage especially for non-continuous operation in decentralized systems with fluctuating hydrogen output, for example in filling stations.

The active surface area of the membrane electrode assembly is advantageously within a range from 5 to 20 000 cm², preferably 25 to 10 000 cm², especially 150 to 1000 cm².

The thickness of the membrane electrode assembly is advantageously within a range from 250 to 1500 μm, preferably 600 to 1000 μm.

At a construction volume of 1 m³, a hydrogen separation stack consisting of end plates, bipolar plates, seals, and membrane electrode assemblies advantageously separates 100 to 200 Nm³/h hydrogen and is accordingly significantly smaller than systems with physical hydrogen separation.

The energy consumption is typically between 3 and 7 kWh/kg H2, depending on the gas composition and chosen separation rate.

Since the electrochemical separation is based on gas-tight, highly selective proton-conducting membranes, the purity of the hydrogen generated can be very high, typically greater than around 99.9%, preferably greater than 99.95%, in particular greater than 99.99%.

Particular preference is given to the following membrane electrode assembly specifications:

| | | | Acid | Acid | Acid | PBI | I.V. |
|---|---|---|---|---|---|---|---|
| | Width | Thickness | concentration | content | content | content | value |
| Specification | (mm) | (μm) | (wt %) | (mg/cm³) | (mg/cm²) | (mg/cm³) | (dL/g) |
| Values | 310 | 360-440 | 51-59 | 760-870 | 30-37 | 65-89 | 4.50-6.00 |

PBI = polybenzimidazole
I.V. = inherent viscosity

Details of the Combination of the Two Systems:

The decomposition of the hydrocarbons and the electrochemical separation are advantageously carried out at the same pressure level. Both stages—thermal decomposition and electrochemical separation—are advantageously carried out at an absolute pressure of 1 bar to 30 bar. The pressure difference between the two stages is advantageously within the range from 0.001 bar to 5 bar.

It is advantageous when, on introduction into the electrochemical separation process stage, the hydrogen-containing product mixture is at the same temperature level it had after the decomposition process stage. The hydrogen-containing product mixture advantageously has after the decomposition process stage a temperature of from 20 to 400° C., preferably from 50 to 300° C., preferably from 80 to 250° C., preferably from 100 to 200° C., especially 120 to 180° C., and is advantageously discharged from the first stage at this temperature (exit temperature).

The cooling of the hot product-containing gas from reaction temperature to this exit temperature can take place for example in a solid bed.

The hydrogen-containing gaseous product mixture is supplied to the electrochemical separation process at a temperature that differs from this exit temperature advantageously by not more than 100° C., preferably not more than 50° C., especially not more than 25° C.

The residual gas mixture remaining after the electrochemical separation process is advantageously recirculated at least partly to the first stage, the pyrolysis reaction. Advantageously 99.99 to 90%, preferably 99.95 to 95%, preferably 99.9 to 98%, especially 99.8 to 99%, of the remaining residual gas mixture is recirculated to the first stage. The residual gas that is not recirculated is advantageously discharged as purge gas. Advantageously 0.01 to 10%, preferably 0.05 to 5%, more preferably 0.1 to 2%, especially 0.2 to 1%, of the remaining residual gas mixture is discharged as purge gas.

The ratio of feed (hydrocarbons) to recirculated gas (residual gas mixture) in the first stage is in kg/kg advantageously 0.01:1 to 1:5, preferably 0.03:1 to 1:2, especially 0.05:1 to 1:1.

Optional Intermediate Steps:

The EHS may optionally be preceded by one or more of the following process steps: heat integration, reforming of NH3 to N2 and H2, hydrogenation of multiple bonds, water-gas shift (WGS). If two or more of the cited intermediate steps are included, it is advantageous when reforming of the hydrogen-containing gaseous product mixture from the thermal decomposition takes place first, before the hydrogenation and/or the water-gas shift.

Reforming of NH3 to N2 and H2:

Basic secondary components in the pyrolysis product stream would, if the EHS membrane comprises acidic components, be absorbed by the latter and as a result adversely alter the properties of the membrane over time. In this case, it is advantageous for a process stage in which the basic components are removed from the product gas stream to be installed upstream of the EHS. For example, NH3 can undergo reforming with catalysts known to those skilled in the art. This selective ammonia reforming (SAR) is very straightforward to design in terms of apparatus (see for example reduction of NOx in automobile exhaust gases with AdBlue).

The removal of ammonia is recommended at values of typically above 1 ppm, preferably at above 10 ppm and especially at above 25 ppm.

Hydrogenation of Multiple Bonds:

Hydrocarbon compounds with multiple bonds (for example olefins or acetylenes) are adsorbed by the EHS catalyst, thereby lowering its activity. Where the pyrolysis product gas comprises more than 10 mol-ppm of hydrocarbon compounds with multiple bonds, it is preferable to employ a hydrogenation process in which the multiple bonds undergo hydrogenation with part of the hydrogen present in the product gas using catalysts known to those skilled in the art of hydrogenation technology to form single bonds that no longer represent a catalyst poison for the EHS.

The removal of hydrocarbon multiple bonds is recommended at values of typically above 1000 ppm, preferably at above 5000 ppm and especially at above 10 000 ppm.

Water-Gas Shift (WGS):

Carbon monoxide is likewise adsorbed by the EHS catalyst, thereby lowering its activity. Thus, if carbon monoxide is formed during the energy input for pyrolysis and the pyrolysis product gas comprises more than 3% CO, it is advantageous if this carbon monoxide, which is damaging to the EHS catalyst, is prior to entry into the EHS converted into further hydrogen and carbon dioxide at low temperature (<400° C.) with the aid of the combustion water also present in the product gas stream, or if necessary with the aid of externally supplied steam, and a WGS catalyst known to those skilled in the art of water-gas shift technology. Unlike carbon monoxide, carbon dioxide is not a catalyst poison for the EHS.

The removal of CO is recommended at a proportion in the gas stream typically of above 0.5% by volume and more preferably above 1% by volume, especially above 3% by volume.

Refueling of Hydrogen Cars:

The hydrogen present after the electrochemical separation can according to the current state of the art be supplied to a hydrogen car.

### EXAMPLES

The process examples were calculated with the aid of the company's thermodynamic simulator Chemasim, which is analogous to Aspen⁺. The reactor design was executed in Excel on the basis of thermodynamic simulation.

The process was by way of example calculated for a H2 capacity of 1000 kg/day, or 42 kg/h.

The value is based on the largest H2 filling stations currently under discussion.

As a measure for comparison purposes, the following process parameters are employed:
As a measure for variable costs:
the natural gas/methane requirement
the electricity consumption
the generation of pyrolytic carbon as a credit
As a measure for capital costs:
the heat-transfer capacity, or transferred specific heat based on amount of product, that is relevant to capital costs.
   In addition, the specific investment costs as stated in today's literature are used.
As a measure of ecology, which is of course the main driver for the development of H2 filling stations:
the carbon footprint of the process including the carbon footprint of the required grid electricity.

For operation of an H2 filling station, the sole practical option is grid electricity, because operation needs to be available around the clock, irrespective of the weather and the position of the sun.

For grid electricity, the future electricity mix forecast for 2030 for the EU 27 was used, which comprises 19% nuclear, 33% fossil, and 48% renewable energy. The data are taken from [7] and represent a European average. This results in a calculated carbon footprint of 190 kg CO2/MWh_{el.} for the electricity mix in the EU 27 in 2030.

It is also assumed that the filling station is connected to a 25 bar natural gas network.

For the process comparison, all processes produce 20 bar of H2.

All examples are calculated assuming zero losses.

### Prior Art

Electrolysis:

The comparison of the inventive processes with the prior art uses electrolysis performance data as published for alkaline electrolysis in [8].

According to these data, the efficiency of the overall system operating at atmospheric pressure and 80° C. is 68%. This corresponds to a specific electrical energy consumption of 48.4 kWh/kg H2. If the H2 is compressed from 1 bar to 20 bar, another 1.6 kWh/kg H2 is required.

The specific electrical energy requirement is therefore 50.0 kWhₑₗ/kg H2 in total.

The specific carbon footprint is then 9.50 kg CO2/kg H2.

32% (=100%−68%) of the electrical energy is converted into heat and must be dissipated into the environment via heat-exchanger surfaces. The specific heat-transfer energy is herewith 22.8 kWh/kg H2.

According to [4], the specific investment cost is €3070 a/t H2.

The intermediate cooling for the H2 compression from 1 to 20 bar requires 1.7 kWh/kg H2.

Specifically, a total of 22.8+1.7=24.5 kWh of heat is thus transferred per kg of H2.

The electrolysis requires herewith per kg of H2:
50.0 kWh of current
24.5 kWh of heat transferrer

and produces per kg of H2:
9.50 kg of CO2

Mini-SMR:

Detailed data for a mini-SMR unit for 90 kg/h H2 are reported in [9]. This corresponds to only twice the capacity of a 42 kg H2/h capacity serving here as a basis for an H2 filling station and is therefore very well suited for the comparison of the prior art with the inventive variants. An update of the cost data based on the process data and list of machines and equipment in [9] is given in [10].

According to this, 3.1 kg of natural gas and 2.1 kWhₑₗ of electricity are required per kg of H2. The natural gas here has the following composition in % by weight: 88.7% CH4, 4.7% C2H6, 3.9% C3H8, 1.3% N2, and 1.3% CO2. The reported electricity requirement covers not just the actual requirement of the process, but also the compression of the natural gas from 7 to 22 bar prior to the process and compression of the H2 from 21 bar to 207 bar after the process. For the actual process, the reported data give rise to an electricity requirement of 0.2 kWhₑₗ/kg H2.

0.04 kg CO2/kg H2 results from the grid electricity supplied and 8.42 kg CO2/kg H2 results from production. In total, the production of 1 kg of H2 according to mini-SMR technology prior art thus produces 8.46 kg of CO2.

The reported values for the heat transferrers give rise to a calculated value of 18.5 kW per kg H2/h for installed specific heat-transfer capacity. However, this does not include the cost-relevant heat-transfer capacity of the reformer. No information on this was provided. According to [9], the specific investment cost of a mini-SMR is € 12 100 a/t H2.

To achieve better comparability of the prior art with the inventive variants, the SMR process published in [9] was recalculated using the company's thermodynamic process simulator Chemasim, which was also used for the calculation of the inventive variants. The unit ratios, operating parameters, and heat-transfer capacities reported in [9] were specified and the unknown heat-transfer capacity for the reformer thus determined. This gives a value of 8.9 kW per kg H2/h. The total specific heat-transfer capacity is thus 18.5+8.9=27.4 kW per kg H2/h.

If 100% CH4 is used in the calculation instead of a natural gas having the composition stated above, the unit ratios and specific heat-transfer capacities change only marginally. For the sake of simplicity, the following results are therefore based on simulations with 100% CH4 as the feed gas.

The mini-SMR requires herewith per kg of H2:
3.10 kg of CH4
0.2 kWh of current
27.4 kWh of heat transferrer

and produces per kg of H2:
8.46 kg of CO2

Tube Trailer H2:

Detailed data for a world-scale SMR plant for 9058 kg/h H2 are reported in [11]. According to the “Major Equipment” list, 847.4 MMBTU/h of heat is—as in the case of the mini-SMR—transferred therefor, which equates to 27.4 kWh/kg H2. However, more natural gas is required in the case of the world-scale plant than in the case of the mini-SMR. The world-scale plant accordingly requires 3.32 kg of natural gas/kg H2 instead of 3.10 kg of natural gas/kg H2 in the case of the mini-SMR. On the other hand, the world-scale plant does however also produce, in addition to H2, 4.4 kg of steam/kg H2. Since the appraisal of steam depends very much on local conditions, it was assumed here for the sake of simplicity that the world-scale plant has the same unit ratios as the mini-SMR. The cost advantage of a world-scale plant over a mini-SMR lies in economy of scale.

For transport, it is assumed that the H2 is transported by road to the filling stations in 500 bar containers on trailers and that these containers are emptied to 21 bar at the filling station before being transported back to the world-scale plant. For transport, the H2 must be compressed from 20 to 500 bar at the world-scale plant [5]. This requires the use of 1.6 kWh/kg H2. This high pressure in the containers is however advantageous when compressing at the filling station to the final pressure of e.g. 950 bar for refueling cars. However, given that the pressure decreases from 500 to 20 bar at the filling station during emptying of the containers, an average initial pressure in the container of (500+20)/2=260 bar is assumed for the comparison with the other variants. This reduces by 1.3 kWh/kg the energy needed for further compression from 260 bar to e.g. 950 bar compared to compression from 20 bar to 950 bar. H2 transport thus ultimately requires the use of 1.6−1.3=0.3 kWh/kg H2 more electricity than in the case of the mini-SMR.

According to [5], the specific investment cost for compression is € 430 a/t H2.

With 500 bar containers, a maximum of 1344 kg of H2 can currently be transported by a 40 t tank truck [5] that is emptied at the filling station down to a pressure of 21 bar. This then leaves behind 54 kg of H2 in the containers, which is returned to the world-scale plant. According to [5], the specific investment cost for the additional expenditure on storage at the filling station is € 4740 a/t H2. The total specific investment cost is then € 430+4740=5170 a/t H2.

It is further assumed that a tank truck of this kind requires 35 liters of diesel per 100 km. In terms of energy content, this corresponds to 31 kg of natural gas per 100 km and currently represents a best figure.

For 42 kg/h of H2, 0.78 journeys per day are necessary (=42*24/(1344−54)). If the energy consumption and associated CO2 emissions are calculated for different distances—e.g. for 100 km and for 500 km—between the centralized world-scale plant and the decentralized filling station, the following results are obtained: The tube trailer variant requires per kg of H2:
3.10 kg of CH4 for generation in the centralized world-scale unit
+0.08 kg of CH4 equivalents in the form of diesel for a distance of 100 km
+0.30 kg of CH4 equivalents in the form of diesel for a distance of 500 km
0.6 kWh of current
27.4 kWh of heat transferrer

and produces per kg of H2:
8.75 kg of CO2 for a distance of 100 km and
9.18 kg of CO2 for a distance of 500 km and

Inventive Process Variants

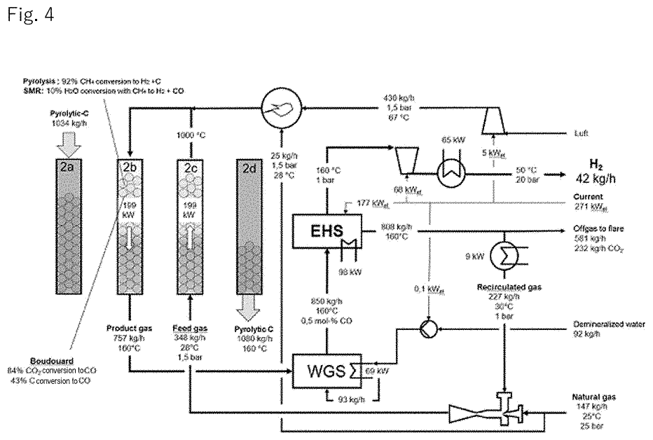

ATP&EHS: (FIG. 4)

An example calculation was carried out for a combination of an autothermally operated pyrolysis (ATP) and an EHS. The advantage of this combination lies in a low consumption of electricity and natural gas and also a low heat-transfer capacity. 42 kg/h of high-purity H2 is generated.

Natural gas is prepurified. This can take place for example by catalytic desulfurization, as described in [9].

147 kg/h of purified natural gas at a pressure level of 25 bar is supplied to the process at ambient temperature (25° C.).

25 kg/h thereof is withdrawn to be burnt in a burner with air to hot burner gas to cover the energy requirement. 430 kg/h of burner air is compressed from ambient pressure and temperature to 1.5 bar. This needs 5 kW of electric power.

The rest of the natural gas is mixed with 227 kg/h of recirculated gas in a jet pump. In the jet pump, the initial pressure of the natural gas is used to compress the recirculated gas from 1.0 to 1.5 bar.

The feed gas enters the particle bed of segment (2c) at a temperature of 28° C. and is heated to 1000° C. therein. This is accompanied by cooling of the particle bed. A temperature front develops, which moves from bottom to top. This is accompanied by a thermal transfer of 199 kW.

During this heating, part of the natural gas already undergoes pyrolysis.

After exiting segment (2c), the gas is mixed with the hot burner gas and further reactions commence.

Although no catalyst is present, it must be assumed that part of the natural gas will be reformed to CO and H2 with the water that is formed during combustion. It is assumed here by way of example that 10% of the combustion water reacts. It is also assumed that the CO2 from the combustion reacts in the particle bed in segment (2b) with the pyrolytic carbon formed to form CO according to the Boudouard equilibrium.

In segment (2b), the hot reaction gas heats the particle bed and is at the same time itself cooled. This is similarly accompanied by a thermal transfer of 199 kW.

The product gas (757 kg/h) cooled to 160° C. comprises 15 mol % of CO. This CO is in a WGS reaction with steam converted to CO2 and H2 down to a residual concentration of 0.2%. The reaction gives rise to 69 kW of excess heat, which must be dissipated. This is done by generating 5 bar of steam, which is needed as additional steam (93 kg/h) for the WGS reaction.

In the EHS, 99% of the H2 formed is separated electrochemically from the product gas of the WGS (850 kg/h). This needs 177 kW of electric power.

The residual anode offgas (808 kg/h) is split into the recirculated gas that is recycled into the process and the offgas that is burned in the flare, thereby generating 232 kg CO2/h. 42 kg/h H2 exits the EHS at a pressure of 1 bar. The compression to 20 bar needs 68 kWₑₗ of electric power. 65 kW must be abstracted from the intermediate cooling as heat flows. In order to be able to provide regenerative heat-transfer capacity of 199 kW in segments (2b) and (2c), 1034 kg/h of fresh pyrolytic carbon must be introduced into segment (2a). 1080 kg/h of pyrolytic carbon is withdrawn from segment (2d). The difference, 46 kg/h, is generated as pyrolytic carbon product.

The ATP&EHS process produces herewith per kg of H2:
1.1 kg of high-purity pyrolytic carbon

and requires therefor per kg of H2:
3.5 kg of CH4
6.0 kWh of current
10.0 kWh of heat transferrer

and produces per kg of H2:
6.7 kg of CO2

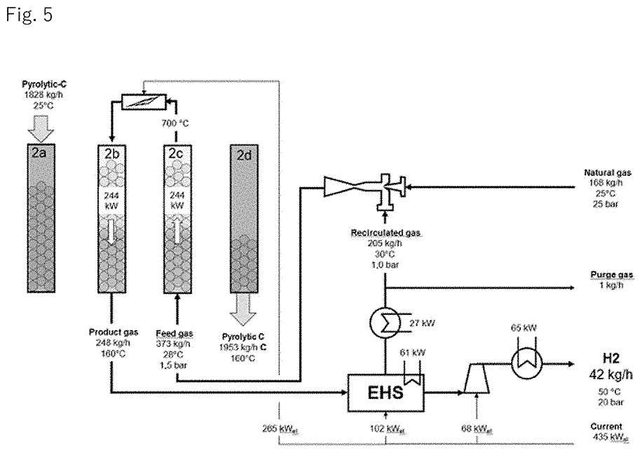

LT Plasma&EHS: (FIG. 5)

An example calculation was carried out for a combination of a pyrolysis operated with a low-temperature plasma (LT plasma) and an EHS. The plasma here has the role of increasing the rate of reaction. The advantage of this combination lies in the relatively low process temperatures and the absence of CO, which has a beneficial effect on the energy requirement of the EHS.

42 kg/h of high-purity H2 is generated.

Natural gas is prepurified. This can take place for example by catalytic desulfurization, as described in [9].

168 kg/h of purified natural gas at a pressure level of 25 bar is supplied to the process at ambient temperature (25° C.) and mixed with 205 kg/h of recirculated gas in a jet pump. In the jet pump, the initial pressure of the natural gas is used to compress the recirculated gas from 1.0 to 1.5 bar.

The feed gas (373 kg/h) enters the particle bed of segment (2c) at a temperature of 28° C. and is heated to 700° C. therein. This is accompanied by cooling of the particle bed. A temperature front develops as a result, which moves from bottom to top. This is accompanied by a thermal transfer of 244 kW.

After exiting segment (2c), the gas molecules are excited in a low-temperature plasma device, for example by means of pulsed microwaves, and then passed into segment (2b). In segment (2b), the hot reaction gas heats the particle bed and is at the same time itself cooled to 160° C. This is similarly accompanied by a thermal transfer of 244 kW.

The product gas (248 kg/h) cooled to 160° C. is passed into an EHS in which 91% of the H2 formed is separated electrochemically from the product gas. This needs 102 kW of electric power.

1 kg/h from the residual anode offgas (206 kg/h) is withdrawn as a purge stream in order to prevent accumulation of inert components.

42 kg/h H2 exits the EHS at a pressure of 1 bar. The compression to 20 bar needs 68 kWₑₗ of electric power. 65 kW must be abstracted from the intermediate cooling as heat flows. In order to be able to provide regenerative heat-transfer capacity of 244 kW in segments (2b) and (2c), 1828 kg/h of fresh pyrolytic carbon must be introduced into segment (2a). 1953 kg/h of pyrolytic carbon is withdrawn from segment (2d). The difference, 125 kg/h, is generated as pyrolytic carbon product.

The LT plasma&EHS process produces herewith per kg of H2:
3.0 kg of high-purity pyrolytic carbon

and requires therefor per kg of H2:
4.0 kg of CH4
10.4 kWh of current
9.4 kWh of heat transferrer

and produces per kg of H2:
2.0 kg of CO2

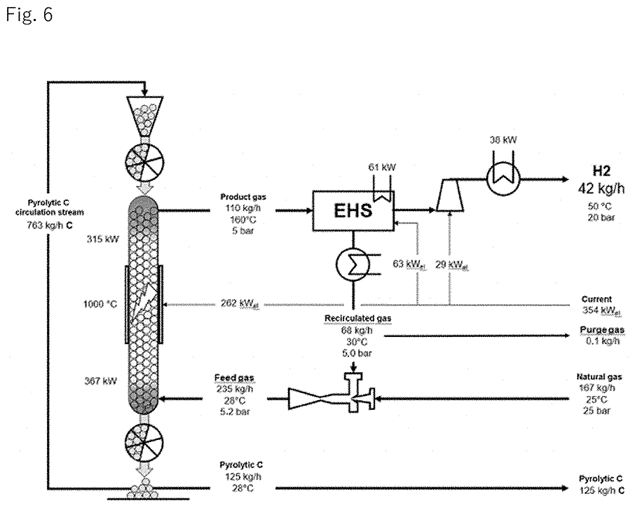

RH Pyrolysis&EHS: (FIG. 6)

An example calculation was carried out for a combination of an electrically heated pyrolysis in which the pyrolytic carbon bed functions as resistance heating (RH pyrolysis) and an EHS. The principle of RH pyrolysis is described for example in U.S. Pat. No. 2,982,622. The advantage of this combination lies in the simplicity of the reactor and in the higher possible operating pressures associated with its construction, which results in smaller reactor dimensions and a subsequently lower expenditure on compression for H2. The absence of CO moreover has a beneficial effect on the energy requirement of the EHS. The combination of the RH pyrolysis with the EHS allows the construction of a gas circuit having a high proportion of H2. The higher H2 level reduces soot formation and additionally lowers the energy requirement in the EHS. In addition, the recirculation of gas opens up new possibilities for conveying the pyrolytic carbon circulation (for example pneumatic conveyance) and enables better heat integration

42 kg/h of high-purity H2 is generated.

Natural gas is prepurified. This can take place for example by catalytic desulfurization, as described in [9].

167 kg/h of purified natural gas at a pressure level of 25 bar is supplied to the process at ambient temperature (25° C.) and mixed with 68 kg/h of recirculated gas in a jet pump. In the jet pump, the initial pressure of the natural gas is used to compress the recirculated gas from 5.0 to 5.2 bar.

The feed gas (235 kg/h) enters the particle bed at the bottom of the fluidized-bed reactor at a temperature of 28° C. and is heated therein to 1000° C. In return, the pyrolytic carbon bed is cooled as it slips downwards. In this countercurrent heat exchange, there is a thermal transfer of 367 kW.

888 kg/h of particles with a temperature of 28° C. is withdrawn from the bottom of the reactor via feeders. 763 kg/h is recirculated for heat integration (367 kW+315 kW) and fed back into the reactor at the top via feeders. 125 kg/h of pyrolytic carbon is withdrawn as a high-purity product.

In the reactor, an electric current is in the reaction zone conducted through the particle bed to cover the heat of reaction (262 kWₑₗ). The heat of reaction of 262 kW thus introduced does not influence the amount of pyrolytic carbon that needs to be recirculated and is therefore not material to capital costs. The carbon formed during methane cracking results in a growth of pyrolytic carbon particles.

The product gas from methane cracking flows upwards and heats the recirculated particles as they slip downwards. In return, the product gas is cooled. The degree of heat integration can be controlled by the amount of recirculating gas. In this countercurrent heat exchange, there is a thermal transfer of 315 kW.

The product gas (110 kg/h) cooled to 160° C. is passed into an EHS in which 50% of the H2 formed is separated electrochemically from the product gas. This needs 63 kWₑₗ of electric power.

The residual anode offgas (68 kg/h) is recirculated. To prevent accumulation of inert components, 0.1 kg/h from the recirculated gas is withdrawn.

42 kg/h H2 exits the EHS at a pressure of 5 bar. The compression to 20 bar needs 29 kWₑₗ of electric power. 38 kW must be abstracted from the intermediate cooling as heat flows.

The RH pyrolysis&EHS process produces herewith per kg of H2:
3.0 kg of high-purity pyrolytic carbon

and requires therefor per kg of H2:
4.0 kg of CH4
8.4 kWh of current
19.2 kWh of heat transferrer

and produces per kg of H2:
1.6 kg of CO2

Comparison:

Table 1 summarizes the results of the example calculations. The results show clearly that the inventive process concepts are able to produce H2 with a smaller carbon footprint than is possible according to the current state of the art. The smaller carbon footprint is the main driver for H2 mobility.

In addition, the heat-transfer capacities for the inventive process concepts that are relevant to capital costs are smaller than in the case of the current state of the art.

The increased consumption of natural gas in the case of the inventive process concepts is offset by the additional recovery of high-purity carbon. This increases the raw material yield and thus the added value.

According to the prior art, an SMR is in terms of mass able to process only about 32% (=1 kg H2/3.1 kg CH4) of the methane used in a value-adding manner. The inventive process concepts are however able to utilize up to 100% (=(1 kg H2+3 kg C)/4 kg CH4) of the methane used.

Moreover, the inventive process concepts have only one fifth to one ninth the power requirement of a water electrolysis. A low power requirement is however important, particularly with regard to the expansion in renewable energies that will be necessary in the future, since mobility is here in competition with other energy consumers.

TABLE 1
Comparison of the results from the example calculations.

| | | Distance of | | Electricity | Pyrolytic | Investment-relevant | Carbon foot- |
|---|---|---|---|---|---|---|---|
| | | ws-SMR from | Natural gas | kWh ₑₗ/kg | carbon | heat-transfer | print |
| | | H2 filling station | kg CH4/kg H2 | H2 | kg C/kg H2 | kWh ₜₕ/kg H2 | kg CO2/kg H2 |
| Prior | Electrolysis | | | 50.0 | | 24.4 | 9.5 |
| art | Mini-SMR | 0 km | 3.1 | 0.2 | | 27.4 | 8.5 |
| | ws-SMR + H2 | 200 km | 3.2 | 0.6 | | 27.4 | 8.7 |
| | transport | 500 km | 3.2 | 0.6 | | 27.4 | 9.2 |
| Inventive | ATP & EHS | | 3.5 | 6.0 | 1.1 | 10.0 | 6.7 |
| examples | LT plasma & | | 4.0 | 10.4 | 3.0 | 9.4 | 2.0 |
| | EHS | | | | | | |
| | RH pyrolysis & | | 4.0 | 8.4 | 3.0 | 19.2 | 1.6 |
| | EHS | | | | | | |

### REFERENCES

A. M. Bazzanella, F. Ausfelder, “Low carbon energy and feedstock for the European chemical industry”, DECHEMA-Technology study, June 2017.
A. I. Pushkarev, et. al. “Methane Conversion in Low-Temperature Plasma”, High Energy Chemistry, vol. 43 No. 3, 2009.
O. Machhammer, A. Bode, W. Hormuth, “Financial and Ecological Evaluation of Hydrogen Production Processes on Large Scale”, Chem. Eng. Technol., 39, No. 39, 2016, pp. 1185-1193.
G. Parks, et. al, “Hydrogen Station Compression, Storage, and Dispensing, Technical Status and Costs”, Technical Report, NREL/BK-6A 10-58564, May 2014.
Lange J.-P., Fuels and chemicals: manufacturing guidelines for understanding and minimizing the production costs, CATECH, volume 5, No. 2, 2001.
“Strommix in EU 27, Entwicklung der Stromerzeugung in Europa von 2007 bis 2030” [Electricity mix in EU 27, development of electricity generation in Europe from 2007 to 2030], an expert view from VDMA Power Systems, www.vdma.org/powersystems.
“Studie über die Planung einer Demonstrationsanlage zur Wasserstoffgewinnung durch Elektrolyse mit Zwischenspeicherung in Salzkavernen unter Druck” [Study on the planning of a demonstration plant for hydrogen production by electrolysis with intermediate storage in salt caverns under pressure] DLR study, 2015, page 33.
Process Economics Program (PEP) Report 32B “SMALL SCALE HYDROGEN PLANTS”, July 2003, SRI Consulting.
PEP Review 2015-10 “Hydrogen Process Summary”, 2015, IHS CHEMICAL.
Process Economics Program (PEP) Report 32C “HYDROGEN PRODUCTION”, September 2007, SRI Consulting.
Peter Häussinger, et. al., Hydrogen, 3. Purification, Ullmann's Encyclopedia of Industrial Chemistry, Wiley-VCH Verlag GmbH & Co. KGaA, Weinheim, 2012.

1.-10. (canceled)

11. A process for producing hydrogen, wherein in a first stage hydrocarbons in a fixed-bed reactor, fluidized-bed reactor or moving-bed reactor in the presence of solid carrier materials having a granule size of 0.05 to 100 mm are decomposed into solid carbon and into a hydrogen-containing product mixture, the hydrogen-containing gaseous product mixture, which has a composition in respect of the main components CH₄, N₂, and H₂ of 20% to 95% by volume H2 and 80% to 5% by volume CH₄ and/or N₂, is discharged from the first stage at a temperature of 50 to 300° C., wherein the cooling of the hot product streams is used to heat the feed streams, and this is supplied at a temperature differing from this exit temperature by not more than 100° C. to an electrochemical separation process and, in this second stage, the hydrogen-containing product mixture is separated in the electrochemical separation process at a temperature of 50 to 200° C. into hydrogen having a purity of >99.99% and a remaining residual gas mixture.

12. The process according to claim 11, wherein the electrochemical separation process in the second stage uses a membrane electrode assembly and the membrane is a polymer membrane selected from the group of sulfonated polyether ether ketones, sulfonated polybenzimidazoles, sulfonated fluorinated hydrocarbon polymers, perfluorinated polysulfonic acids, styrene-based polymers, poly(arylene ethers), polyimides, and polyphosphazenes.

13. The process according to claim 12, wherein polybenzimidazoles based on polybenzimidazole and phosphoric acid are used as polymer membranes.

14. The process according to claim 11, wherein the decomposition in the first stage is carried out at a temperature of 900° C. to 1200° C. for a residence time of 1 s to 1 min.

15. The process according to claim 11, wherein the cooling of the hot product-containing gas from reaction temperature to an exit temperature of 50° C. to 300° C. takes place in a solid bed.

16. The process according to claim 11, wherein 90 to 99.99% of the amount of residual gas remaining from the electrochemical separation process is recirculated to the first stage.

17. The process according to claim 11, wherein the composition in respect of the main components CH₄, N₂, and H₂ is from 80% to 90% by volume H2 and 20% to 10% by volume CH₄ and/or N₂.

18. The process according to claim 11, wherein no catalyst is present in the first stage.

19. The process according to claim 11, wherein the pyrolysis product gas comprises more than 3% CO.

20. The process according to claim 11, wherein both stages are carried out at an absolute pressure of 1 bar to 30 bar and the pressure difference between the two stages is within a range from 0.001 bar to 5 bar.

21. The process according to claim 11, wherein the energy required for the decomposition reaction in the first stage is provided autothermally or via low-temperature plasma.

22. The process according to claim 11, wherein the autothermal pyrolysis process comprises the following steps:
1) Providing a particle bed composed of a carrier material.
2) Burning a reactant gas or product gas with air to produce a hot pyrolysis gas for providing the enthalpy of reaction.
3) Mixing this hot pyrolysis gas with the reactant gas, such that the reactant gas pyrolyzes to H2 and carbon.
4) Contacting the particle bed of carrier material with the carbon-containing hot pyrolysis gas, such that the particle bed of carrier material is heated and carbon is deposited in the particle bed.
5) Passing cold reactant gas over this heated particle bed, such that the reactant gas is heated and the carbon-laden particle bed is cooled.
6) Replacing the cooled, laden particle bed with a cold particle bed.

23. The process according to claim 11, wherein the low-temperature plasma pyrolysis process comprises the following steps:
1) Providing a particle bed composed of a carrier material.
2) Contacting the particle bed of carrier material with the carbon-containing hot pyrolysis gas, such that the particle bed of carrier material is heated and carbon is deposited in the particle bed.
3) Passing cold feed gas consisting of reactant gas and recirculated gas over this heated particle bed, such that this feed gas is heated and the carbon-laden particle bed is cooled.
4) Further heating of the feed gas by a plasma burner to produce the hot pyrolysis gas.
5) Replacing the cooled, laden particle bed with a cold particle bed.

24. The process according to claim 11, wherein the hydrogen present after the electrochemical separation process is supplied to a hydrogen car.
